(19) United States
(12) Patent Application Publication
(10) Pub. No.: US 2026/0057335 A1
(43) Pub. Date: Feb. 26, 2026

(54) AUTONOMOUS VEHICLE DELIVERY WITH INTEGRATED COMMUNICATION AND CONTROL SYSTEMS

(71) Applicant: SKYHAUL AEROSPACE AND MARINE SERVICES CORPORATION, Dayton, KY (US)

(72) Inventors: Kevin Bruns, Dayton, KY (US); Robert Ziegler, Independence, KY (US)

(21) Appl. No.: 19/307,090

(22) Filed: Aug. 22, 2025

Related U.S. Application Data
(60) Provisional application No. 63/686,405, filed on Aug. 23, 2024.

(51) Int. Cl. G06Q 10/0832; B63B 35/52; G05D 1/667; G05D 105/28; G05D 109/20

(52) U.S. Cl. CPC G06Q 10/0832; B63B 35/52; G05D 1/667; G05D 2105/28; G05D 2109/20

(57) ABSTRACT

Various implementations disclosed herein include devices, systems, and methods that enable an autonomous vehicle to deliver items to moving vessels via an aerial payload catch arm structure removably attached to universal structures of a marine vessel. For example, a structure may include a first elongated structure pivotably attached to a second elongated structure. The second elongated structure includes an attachment structure configured to removably attach the second elongated structure to a structure on a vessel. The structure may further include a third elongated structure pivotably attached to the first elongated structure and a platform structure comprising a porous platform. The platform structure is attached to the third elongated structure such that the platform structure in combination with the third elongated member and the first elongated member is configured to rotate around the second elongated member to move the platform structure between positions for an autonomous vehicle delivery.

### CROSS-REFERENCE TO RELATED APPLICATION

This application claims the benefit of U.S. Provisional Application Ser. No. 63/686,405 filed Aug. 23, 2024, which is incorporated herein by this reference in its entirety.

### TECHNICAL FIELD

The present disclosure generally relates to devices, systems, and methods that enable an autonomous vehicle to deliver items to vessels via an aerial payload catch arm structure.

### BACKGROUND

Existing techniques for providing deliveries to targets in motion may be improved with respect to simplicity and accuracy.

### SUMMARY

Various implementations disclosed herein include devices, systems, and methods that enable an autonomous vehicle to deliver items (e.g., products such as groceries, hardware items, supplies, etc.) to vessels (e.g., a marine vessel such as a ship) via an aerial payload catch arm structure removably attached to a structure (e.g., a universal cleat) of a marine vessel.

In some implementations, an autonomous vehicle may comprise any vehicle that does not require a human operator to be located within the vehicles such as, inter alia, a remote controlled vehicle (e.g., an aircraft flown by a pilot at a ground control station), an autonomously controlled vehicle (e.g., an aircraft controlled based on pre-programmed flight plans and may include an intelligence algorithm that would enable the vehicle to know its location and self-determine a route to a marine vessel), a pre-programmed vehicle, a robotic based structure, etc. In some implementations, an autonomous vehicle may be, inter alia, an aerial vehicle, a land-based vehicle, a marine (water) based vehicle, etc.

In some implementations, the payload catch arm structure may be configured to receive payloads of differing weights (e.g., 30 or more lbs.) via autonomous vehicle delivery.

In some implementations, the payload catch arm structure is configured to be securely and removably attached to a mooring cleat (e.g., a Kevlar mooring cleat) on differing marine vessels.

In some implementations, a payload receiving structure comprises: a first elongated structure pivotably attached to a second elongated structure, the second elongated structure comprising an attachment structure configured to removably attach the second elongated structure to a structure on a vessel; a third elongated structure pivotably attached to the first elongated structure; and a platform structure comprising a porous platform, the platform structure attached to the third elongated structure such that the platform structure in combination with the third elongated member and the first elongated member is configured to rotate around the second elongated member to move the platform structure from position associated with receiving an object from an autonomous vehicle to a position associated with removing the object from the platform structure.

In some implementations, a device has a processor (e.g., one or more processors) that executes instructions stored in a non-transitory computer-readable medium to perform a method. The method performs one or more steps or processes. In some implementations, the device obtains a request to deliver at least one item to a water vessel and in response to the request, the at least one item is brought to an initial location of an autonomous vehicle and loaded onto the autonomous vehicle. In some implementations, the autonomous vehicle is deployed such that the autonomous vehicle with the at least one item initiates travel to the water vessel. In some implementations, sensor data is obtained from the autonomous vehicle. The sensor data may indicate a location of a payload receiving structure on the water vessel and based on the sensor data, a command may be issued causing the autonomous vehicle to be positioned above the payload receiving structure and release the at least one item onto the payload receiving structure. In some implementations, an indication that the at least one item has been received at the water vessel is received.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1C illustrate first perspective views of an exemplary payload catch arm structure, in accordance with some implementations.

FIG. 2 illustrates views of an exemplary payload catch arm structure, in accordance with some implementations.

FIGS. 3A-3C illustrate second perspective views of an exemplary payload catch arm structure, in accordance with some implementations.

FIGS. 4A-4D illustrate is a flowchart representation of an exemplary method that controls an autonomous vehicle delivery sequence, in accordance with some implementations.

FIG. 5 illustrates is a flowchart representation of an exemplary method enabling a system to control an autonomous vehicle delivery sequence with respect to a moving marine vessel, in accordance with some implementations.

FIG. 6 illustrates is a flowchart representation of an exemplary method that enables a system to control an autonomous vehicle payload delivery sequence with respect to a moving vessel, in accordance with some implementations.

FIG. 7 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

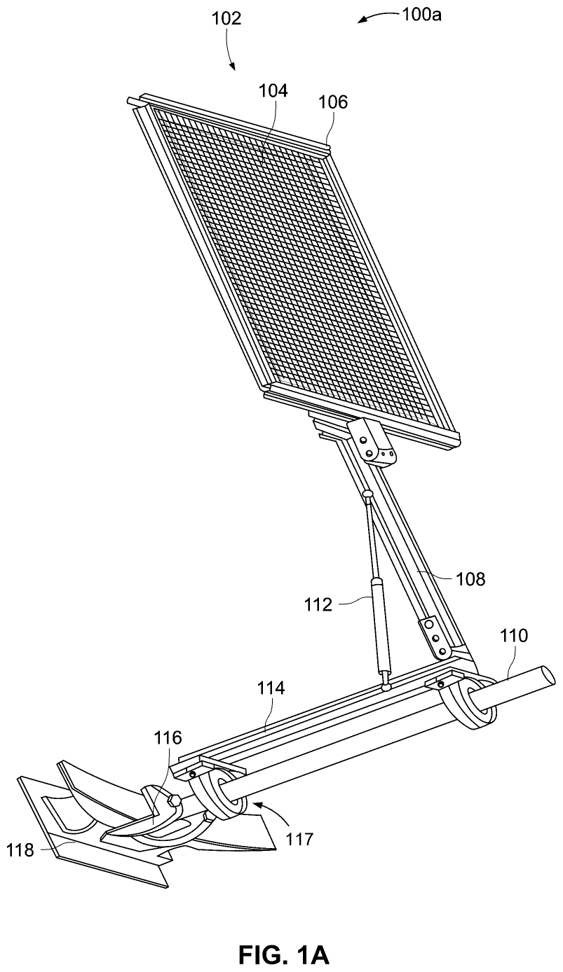

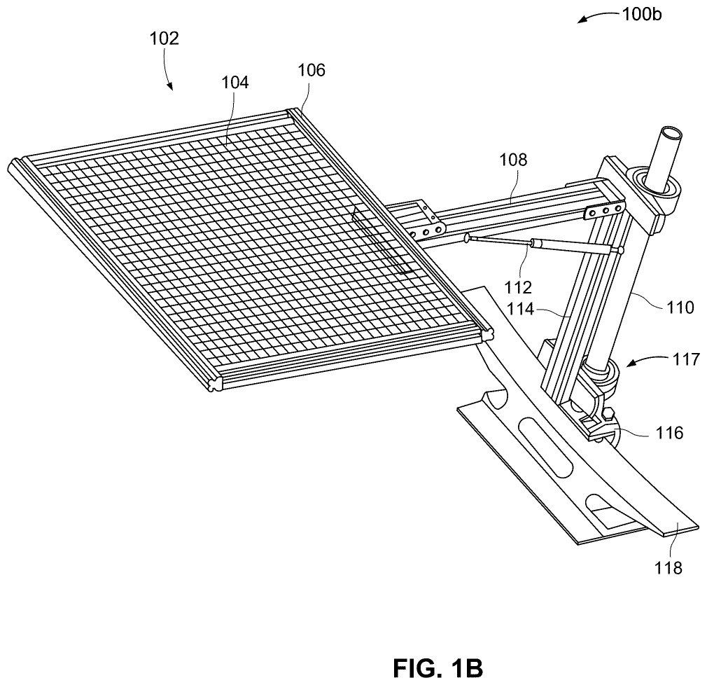

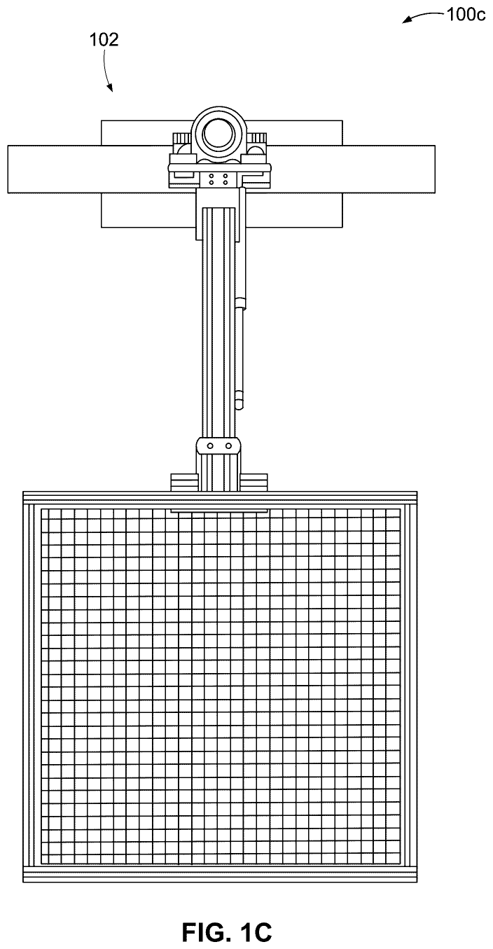

FIGS. 1A-1C illustrate perspective views 100a, 100b, and 100c of an exemplary payload catch arm structure 102, in accordance with some implementations.

FIG. 1A illustrates a first perspective view 100a illustrating payload catch arm structure 102 that includes a first elongated structure 114 (e.g., arm) pivotably attached to a second elongated structure 110 (e.g., cylindrical in shape) and a third elongated structure 108 (e.g., arm) pivotably attached to the first elongated structure 114. The payload catch arm structure 102 may further include a platform structure 106 (e.g., including a porous material 104 such as netting or screening material) attached/connected to a support strut 112 and the second elongated structure 110 such that it is configured to reach out away from the marine vessel and over the water so that it may catch payload in specialized bags being dropped from the autonomous vehicle. Likewise, the payload catch arm structure 102 may be configured to articulate in a circular direction (e.g., 20 degrees or more) to move the platform structure 106 from a position over the water to a position over a deck location of a marine vessel so that a crewman or robotic structure may safely receive the payload without having to reach out or cantilever over the water or vessel deck.

In some implementations, the payload catch arm structure 102 may include an electrical motor 117 (e.g., rotary motor, stepper motor, linear movement motor, etc.) and controller to articulate the platform structure 106 in a circular direction to ease unloading of payloads for the crewman. In this instance, the electrical motor 117 may be powered by a battery pack located on or within the payload catch arm structure or via power from the vessel. The electrical motor 117 may be activated directly by crewman onboard the vessel (e.g., via switches or an interface) or remotely via flight control software by a pilot of the autonomous vehicle. In some implementations, the payload catch arm structure 102 and/or the vessel may be configured to provide an indication that the payload has been received at the payload catch arm structure 102.

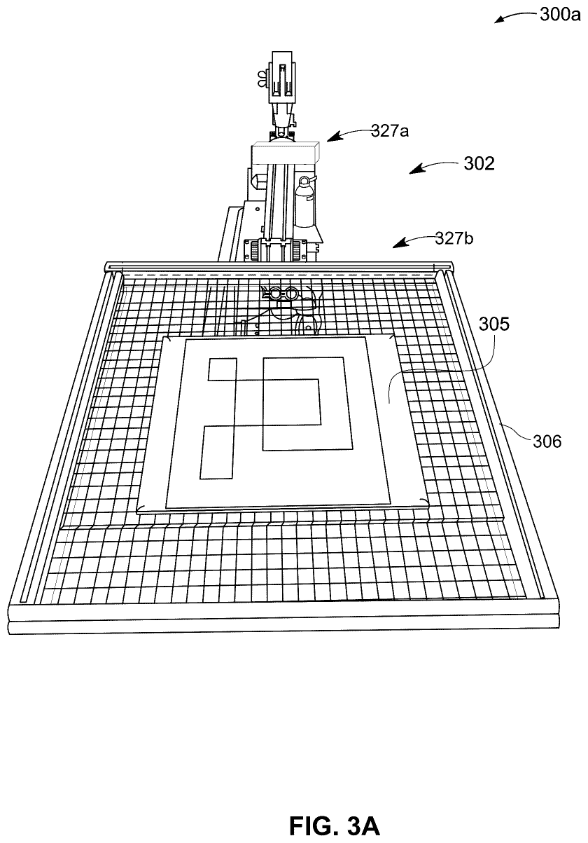

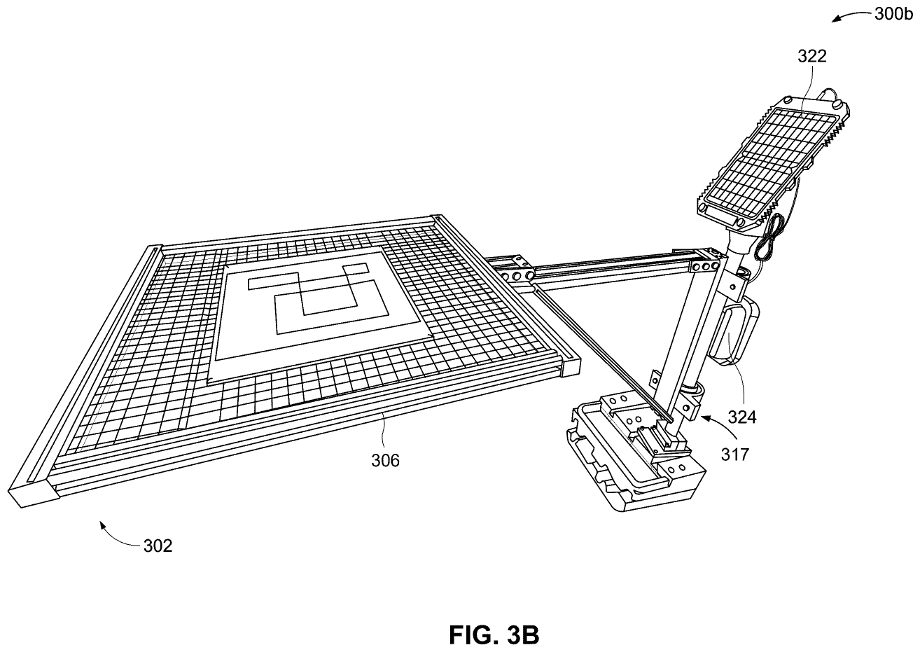

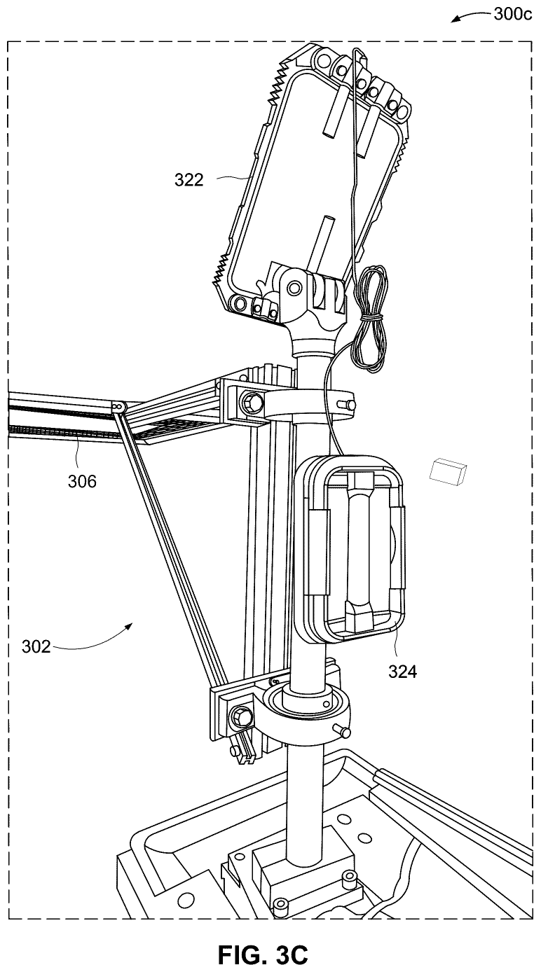

In some implementations, a 2-dimensional marker that includes encoded information readable/decodable by a scanner (e.g., an marker that ArUco marker or QR code as illustrated by marker 305 in, for example, FIGS. 3A-3C) may be placed on or integral with an upper facing surface of the platform structure 106 and may be illuminated via light emitting diode (LED) lighting (of the payload catch arm structure or external to the payload catch arm structure). The 2-dimensional marker in combination with the LED lighting may be scanned/decoded/used by the autonomous vehicle for precision positioning and tracking of the payload drop target as the marine vessel may be underway (moving) throughout the delivery. In some implementations, the LED lighting may include an infrared LED strobe beacon located on the outer edge of the platform structure 106 (or any location with respect to the payload catch arm structure 102). The infrared LED strobe beacon may be used by the autonomous vehicle to locate the platform structure 106 as a target for location and positioning.

In some implementations, the payload catch arm 102 structure may include a solar panel (e.g., solar panel 322 in FIG. 3B) and/or waterproof battery pack (e.g., waterproof battery pack 324 in FIG. 3B) installed for powering the LED lighting, the infrared LED strobe beacon and/or an electrical motor 117 and controller to articulate the platform structure 106 in a circular direction.

In some implementations, a GPS tracking apparatus placed proximate or on the payload catch arm structure 102 may be implemented to enable the autonomous vehicle to track a location of the payload catch arm structure 102.

In some implementations, the payload catch arm structure 102 includes an adjustable clamping device 116 to securely and removably attach the payload catch arm structure 102 to a mooring cleat 118 (e.g., a Kevlar mooring cleat) of a marine vessel.

FIG. 1B illustrates a second perspective view 100b illustrating the payload catch arm structure 102.

FIG. 1C illustrates a top-down view 100c illustrating payload catch arm structure 102.

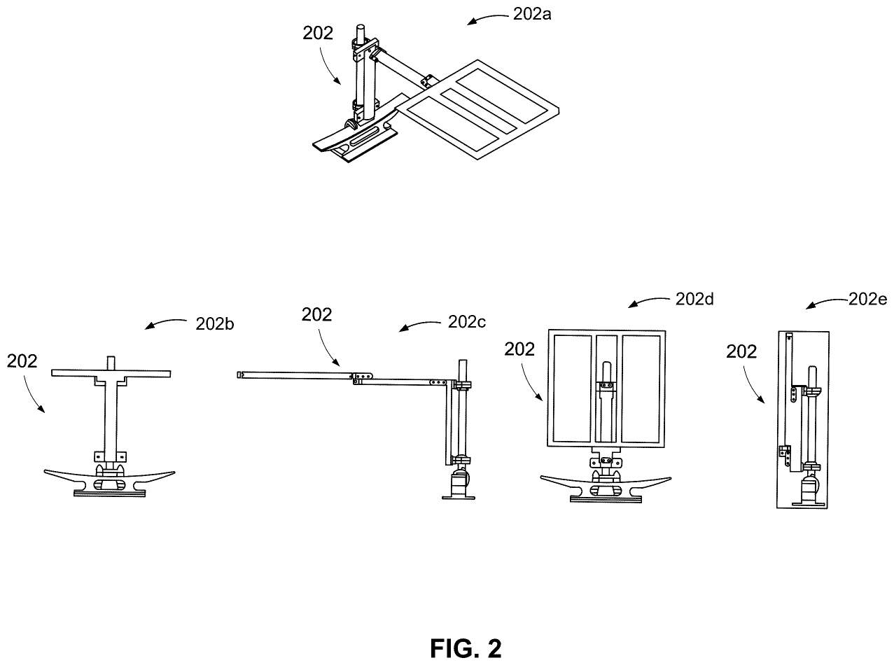

FIG. 2 illustrates perspective views 200a-200e of an exemplary payload catch arm structure 202, in accordance with some implementations.

FIGS. 3A-3C illustrate perspective views 300a-300c of an exemplary payload catch arm structure 302, in accordance with some implementations. The payload catch arm structure 302 of FIGS. 3A-3C is similar to the payload catch arm structure 102 of FIGS. 1A-1C

FIG. 3A illustrates perspective view 300a of payload catch arm structure 302 with a 2-dimensional marker 305. For example, the 2-dimensional marker 305 may be an ArUco marker or QR code placed on an upper facing surface of platform structure 306 and may be illuminated via LED lighting (of the payload catch arm structure or external to the payload catch arm structure). The 2-dimensional marker in combination with the LED lighting may be used by an autonomous vehicle for precision positioning and tracking of the payload drop target as the marine vessel may be in motion throughout the delivery. In some implementations, LED lighting such as an infrared LED strobe beacon structure 327a and/or an LED structure 327b located on an elongated member and/or the outer edge of the platform structure 306 may be used by the autonomous vehicle to locate the platform structure 306 as a target for location and positioning.

FIG. 3B illustrates a perspective view 300b of payload catch arm structure 302 with a solar panel 322 and waterproof battery pack 324 (e.g., including a battery and an enclosure). The solar panel 322 and/or waterproof battery pack 324 may be used for powering LED lighting, an infrared LED strobe beacon and/or an electrical motor 317 and controller to articulate a portion of the payload catch arm structure 302 in a circular direction.

FIG. 3C illustrates a perspective view 300c of payload catch arm structure 302 with a solar panel 322 and waterproof battery pack 324.

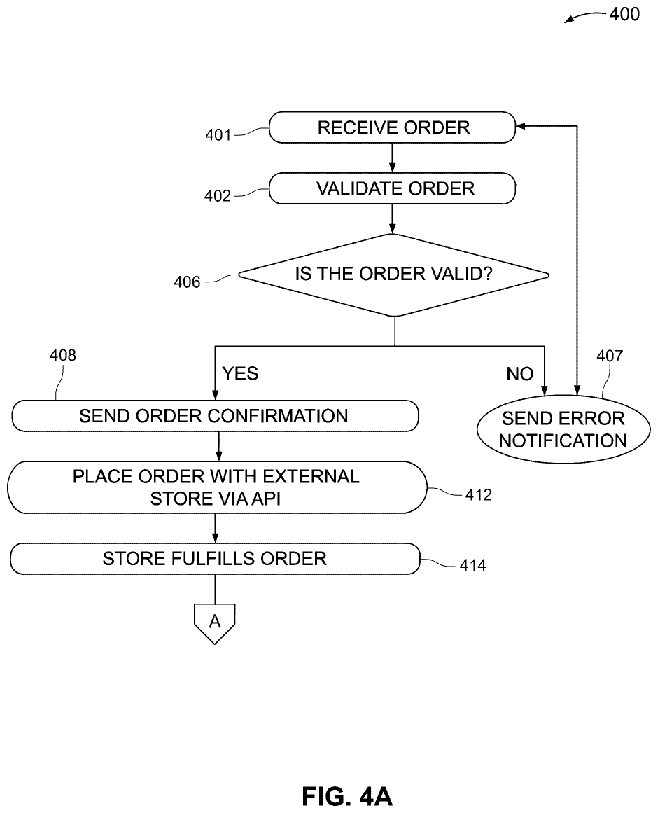

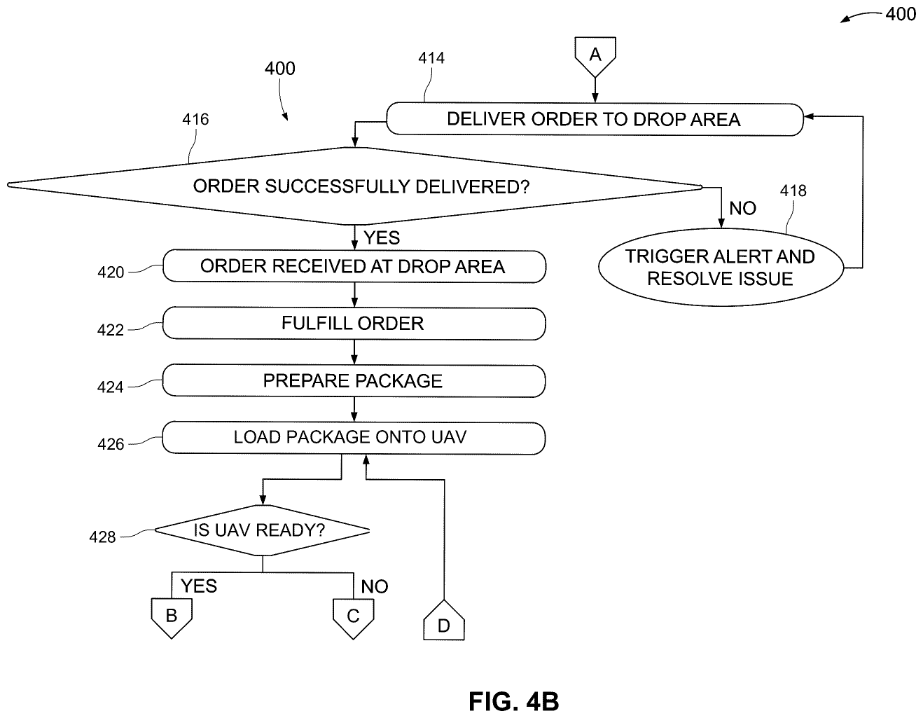

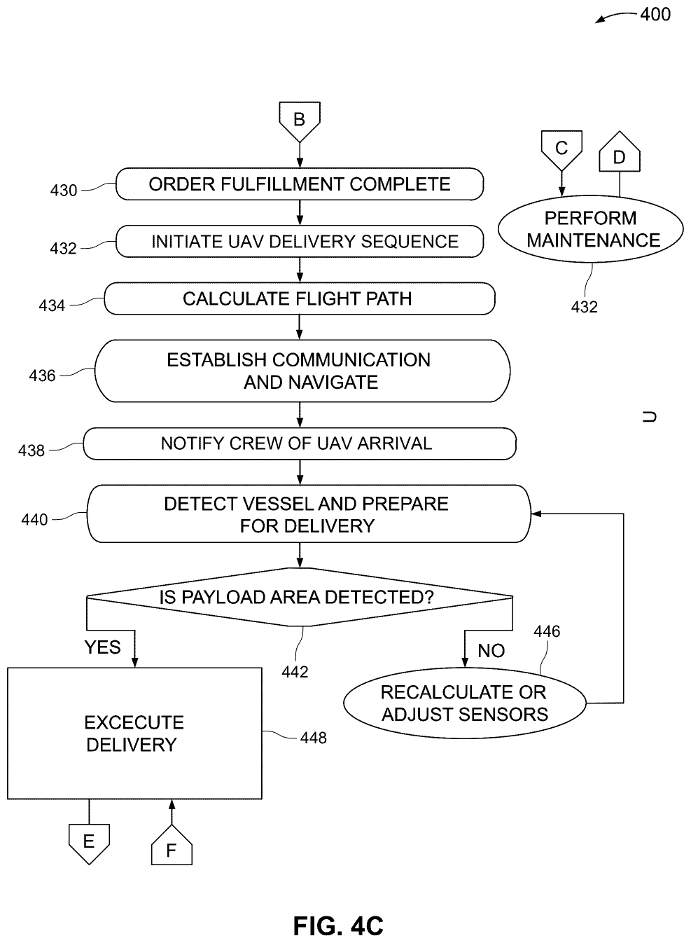

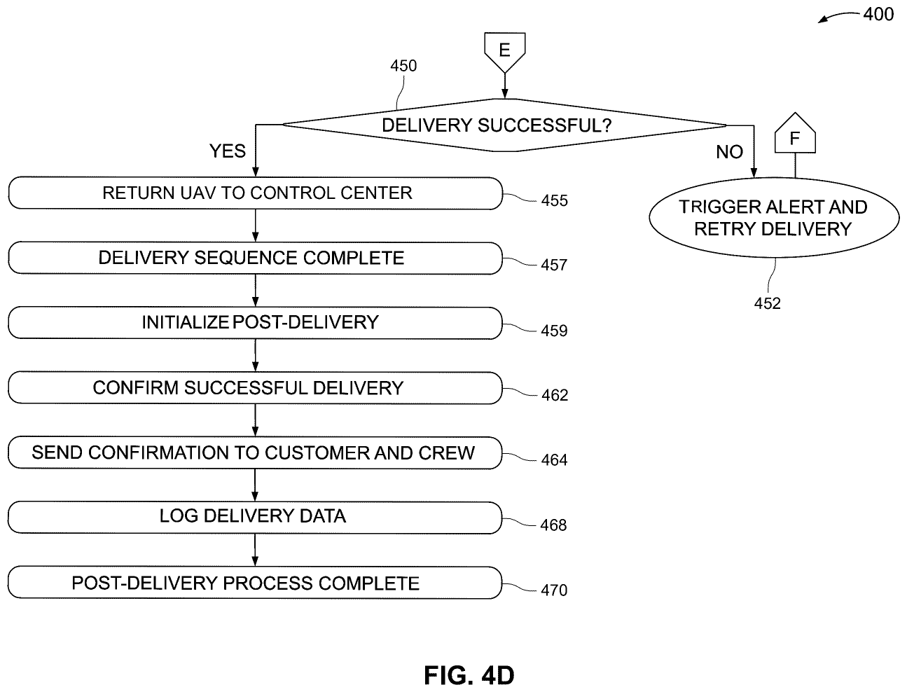

FIGS. 4A-4D illustrate is a flowchart representation of an exemplary method 400 enabling a system to control an autonomous vehicle delivery sequence, in accordance with some implementations.

In some implementations, a system and method may be implemented for delivering packages to a moving vessel utilizing an unmanned aerial system (UAV) that includes an unmanned aerial vehicle (UAV) and a (mobile) control center. The mobile control center may rely on satellite technology to establish a secure and fault-tolerant internet connection, enabling it to fetch data from APIs, send notifications, and manage operations through a web application. Communication between the control center and the UAV may be maintained via 900 MHz telemetry radios or an LTE VPN tunnel, ensuring reliable command and control. The UAV may be equipped with GPS navigation and advanced sensor technologies for real-time tracking and precise navigation. Upon receiving a package from the control center, the UAV may autonomously fly to a dynamically calculated position of the moving vessel. The UAV may use real-time data from onboard sensors, GPS, and communication with the control center to adjust its flight path and descent trajectory. After delivering the package, the UAV may autonomously return to the mobile control center for preparation for a next delivery. The system may ensure reliable and efficient delivery operations, even in remote environments, by leveraging multiple communication channels and advanced control mechanisms.

In some implementations, a system and method may be implemented for the autonomous delivery of goods to a moving vessel using an UAV in conjunction with a mobile control center. The control center may utilize satellite technology to establish a secure and reliable internet connection, enabling seamless operation of a web application that manages delivery orders, customer notifications, and pilot communications. The UAV may communicate with the control center via 900 MHz telemetry radios or an LTE VPN tunnel, ensuring robust connectivity for command-and-control operations. The UAV may be programmed to receive a package at the control center, upload the destination coordinates of the moving vessel, and autonomously navigate to the vessel's location using GPS. The UAV may synchronize with the vessel's movement, ensuring precise and accurate delivery. After completing the delivery, the UAV may return autonomously to the control center. This system provides a reliable solution for delivering goods to vessels in motion, utilizing secure communication channels and advanced navigation technologies to ensure safe and efficient operations.

In some implementations, a mobile control center designed for managing UAV operations may be enabled for delivering packages to moving vessels. The mobile control center may use satellite technology to establish a secure and fault-tolerant internet connection, which supports a web application for real-time order management, notifications, and data processing. The UAV may communicate with the control center via 900 MHz telemetry radios or an LTE VPN tunnel, ensuring reliable and uninterrupted command and control. The UAV may be equipped with GPS and precision sensors, enabling it to autonomously navigate to the moving vessel, adjust for movement, and deliver the package accurately. After delivery, the UAV may autonomously return to the control center, where it may undergo recharging and preparation for subsequent deliveries. The system integrates multiple communication channels to ensure continuity and reliability in various operational scenarios, making it suitable for complex delivery missions in dynamic environments.

In some implementations the following autonomous vehicle delivery sequence may be executed via method 400:

At block 401, a web application receives an order from a customer. The order may include information associated with items (e.g., food, hardware, etc.) to be delivered, a customer's vessel location (current and anticipated), and a time window for delivery.

At block 402, the method 400 validates the received order to ensure that it may be fulfilled within the specified parameters. The validation process may include various assessments such as: (a) inventory availability assessments enabling the system to determine whether items requested in the order are available within inventory of an external entity or may be procured within a required time frame; and (b) time window assessments enabling the system to determine whether the requested delivery time window is achievable based on current order volume, UAV availability, and expected travel time to the delivery location. If the order is not determined to be valid at block 406, then at block 407 the system transmits an error notification and the method repeats step 401.

If the order is determined to be valid at block 406, then at block 408 the system transmits an order confirmation to the customer and relevant crew members via SMS, email, or an in-app notification. This confirmation may include details of the order, an expected delivery time, and tracking information.

At block 412, the method 400 automatically places (e.g., via a web application) the customer's order with an external store using API integration. At block 414, the method 400 enables an external store to receive the order through the API, process it, and prepare the items for delivery.

At block 414, the method 400 enables the external store to deliver the prepared order to a designated drop area corresponding to the mobile control center. At block 416, the method 400 confirms receipt of the order at the drop area. The confirmation may include verifying that all items are accounted for and ready for the next step in the delivery process. If the confirmation is not successful, then at block 418 an alert is triggered to resolve the issue and step 414 is repeated. If the confirmation is successful, then at block 420, the order is confirmed to be received at the drop area.

At blocks 422, 424, 426 428 and 430, the method 400 fulfills the order and prepares the package. For example, the order may be processed by an operations team at the mobile control center, the items may be packed into a secure delivery container and loaded on the UAV and the UAV may be prepared for launch or maintenance.

At block 432, the method 400 enables the drone delivery sequence to be initiated by the web application in coordination with the UAV and the control center.

At block 434, the method 400 calculates an optimal flight path from the control center to the moving vessel. This calculation takes into account the vessel's current speed, direction, and GPS coordinates, as well as environmental factors such as wind speed, waterway currents and obstacles.

At block 436, the method 400 enables the control center to establish communication with the UAV via, for example, 900 MHz telemetry radios or an LTE VPN tunnel. For example, the UAV may be launched and begin autonomous navigation towards the moving vessel via a pre-calculated flight path. Likewise, the control center may continuously monitor the UAV's position and adjust the flight path as necessary.

At block 438, the method 400 sends a notification to the vessel's crew indicating the estimated arrival time of the UAV. For example, notifications may be sent via SMS, email, or application push notifications to provide the crew with a time to prepare for the UAV arrival.

At block 440, the method 400 detects the vessel and prepares for delivery. For example, as the UAV approaches the vessel, it may use onboard sensors (e.g., GPS, cameras, etc.) to detect and confirm the vessel's position and designated payload drop area. In response, the UAV may adjust its descent and hover over the drop zone ready to release the package. If the payload drop area is not detected at block 442, then at block 446, the sensors are adjusted and step 440 is repeated. If the payload drop area is detected at block 442, then at block 448, a delivery sequence is executed. For example, the UAV may release the package onto the vessel's designated payload area, ensure the package is securely dropped, and confirm successful delivery before departing.

At block 450, the method 400 determines if the delivery was successful. If the delivery was not successful, then in block 452 an alert is triggered and delivery is attempted again at block 448. If the delivery was successful then at block 455, the UAV autonomously returns to the mobile control center and the delivery sequence is determined to be complete at block 457. For example, the UAV may follow a safe flight path back to the control center where it lands for recharging and maintenance in preparation for a next mission.

At block 459, the method 400 initializes a post-delivery process that includes confirming a successful delivery at block 462 and sending confirmation of the successful delivery to a customer and crew at block 464. The delivery confirmation may include relevant details regarding the delivery including, for example, a link to track the delivery history and/or provide feedback on the service.

At block 468, delivery data is logged and at block 470, the post delivery process is terminated.

In some implementations, the following software application/microservice functionality may be implemented with respect to the method 400 based on user application:

User management microservice functionality configured to enable: user registration and management for all users; user create, read, update and delete (CRUD) operations; user role CRUD operations with respect to a per-vessel or per-organization basis; user permission CRUD operations; user role permission CRUD operations with respect to a per-vessel or per-organization basis; user role type differentiation; user and user role permission validation for various features; and notification preferences modification.

User authentication microservice functionality configured to: enable and monitor user authentication for all users; provide two factor authentication (2FA) options; authenticate user login credentials; authenticate web tokens; distribute web tokens upon authentication; and lock out user accounts after violating failed login policy.

Notifications microservice functionality configured to enable: push notifications to users; Email; short message service (SMS); application push notifications; and post cards.

Inventory management microservice functionality configured to: enable users to browse, search, and view available inventory within a current zone; display available vendors in a given area; display available stock for each vendor in an area; display local availability for individual items or vendors; display product information for each available stock item; allow for searching available stock; enable freeform search; and determine location, vendor, stock type category, subtype (per vendor/category), etc.

Order management microservice functionality configured to enable: users to create and manage orders; shopping cart CRUD operations; view historic orders; view order status; display order-by deadline informed by vessel speed and location; order processing; finalization; payment; and order placement verification.

Telemetry tracking microservice functionality configured to: record telemetry for all vehicles involved; track real-time flight paths of UAV deliveries; track individual UAV delivery missions and payloads; track velocity and location of destination vessels; track position and route of carrier vans; and track carrier van missions and total payloads.

Feedback microservice functionality configured to enable: users to notify an entity of missing items to reschedule delivery; and users to request refunds for damaged items.

Training and certification microservice functionality configured to enable: a client portal for all entity training, testing, and certification; and access training materials, courses, and certification exams.

Flight crew notification and management microservice functionality configured to enable: order notifications, including store location details, to be sent to flight crew members; flight crew members to receive notifications corresponding to required lead-times for deliveries; gross weight estimates associated with orders for flight crew members; an itemized order checklist by delivery bin for flight crew members; an estimated vessel arrival time for flight crew members; automated invoice generation for clients; assignment of pre-flight and post-flight checklists to UAVs for flight crew members; maintenance requirement tracking and upcoming maintenance action notification transmission; maintenance record recording including motor hours, battery charge logs, overhaul information, etc.; recording of flight log and aircraft telemetry data; transmission of notifications regarding supplies and maintenance issues.

Delivery zone management microservice functionality configured to: determine appropriate delivery zones for items ordered, such as food supplies, products, medications, etc.; and allow flight teams to receive notifications of delivery zone changes and updates.

Chief pilot dashboard microservice functionality configured to: provide a chief pilot with a real-time view of order and flight information; enable a chief pilot to be able to monitor the real-time status of vehicles, aircraft, and orders; and enable access to real-time inflight camera views to be available to the chief pilot.

Containerization and orchestration microservice functionality configured to: containerize each microservice; and utilize Kubernetes to orchestrate the deployment, scaling, and management of microservice containers.

In some implementations, a software application may be built as a collection of microservices, each responsible for a specific domain or functionality. These microservices may be containerized using Docker and orchestrated using Kubernetes to ensure scalability, reliability, and easy management of the application.

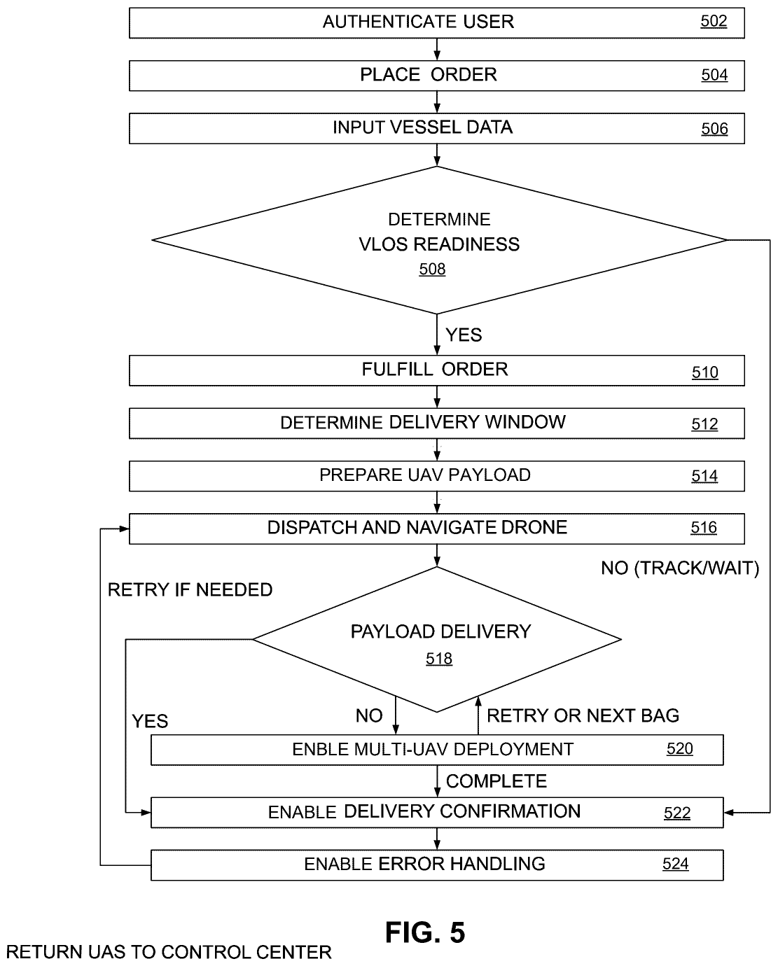

FIG. 5 illustrates is a flowchart representation of an exemplary method 500 for enabling a system to control an autonomous vehicle delivery sequence with respect to a moving marine vessel, in accordance with some implementations. In some implementations, the method 500 may be performed by a device, such as a mobile device, desktop, laptop, a dedicated controller, or server device. In some implementations, the method 500 is performed by processing logic, including hardware, firmware, software, or a combination thereof. In some implementations, the method 500 is performed by a processor executing code stored in a non-transitory computer-readable medium (e.g., a memory). Each of the blocks in the method 500 may be enabled and executed in any order.

In some implementations, the method 500 represents an autonomous vehicle-based delivery sequence of a mobile control connect system designed to deliver items (e.g., groceries, supplies, etc.) to a moving marine vessel such as, for example, a ship or barge navigating inland waterways (e.g., rivers, lakes, bays, etc.) in compliance with visual line of sight (VLOS) regulations. The method 500 initializes with user authentication and terminates with error handling functionality and incorporates multiple hardware/software based microservices and advanced technologies to ensure precision, scalability, and security for regulatory and commercial maritime applications.

At block 502, the method 500 enables the user (e.g., a mariner) to log into the system (e.g., via a mobile application) via a native interface using secure two-factor authentication. Block 502 leverages a user management microservice employing AES-256 encryption to maintain commercial/governing entity maritime compliance standards to ensure secure access for authorized users on vessels.

At block 504, the method 500 enables the user (via the native interface) to review a catalog of available items (supporting over 100 stock-keeping units or SKUs) and places an order for items. An order management microservice may be configured to facilitate block 504 by integrating with an external store's API to process the order request.

At block 506, the method 500 enables the application to input vessel-specific data, including an identifier, a route, and a speed (ranging from 0 to 20 knots). In some implementations, a telemetry tracking microservice may retrieve this data via a marine traffic API, for example updated every 30 seconds, to establish a real-time tracking baseline.

At block 508, the method 500 uses visual line of sight (VLOS) readiness to assess a vessel's position using GPS and the marine traffic API data to predict when it will enter a pilot's visual line of sight (e.g., up to 2 miles). In some implementations, a telemetry tracking microservice verifies that the vessel's speed is less than or equal to a threshold speed (e.g., 20 knots) and will be within VLOS within a specified timeframe (e.g., 30 minutes). If the aforementioned conditions are satisfied, the method 500 advances to block 510. If the aforementioned conditions are not satisfied, the method 500 continues tracking and/or notifies the user (e.g., via SMS/email with respect to a feedback microservice) to adjust the route or delay the order.

At block 510, the method 500 forwards the order to the system, which directs the order to an external delivery service. In response, the ordered items are collected and transported to a designated shore-based delivery zone along a waterway managed by an order management microservice.

At block 512, the method 500 enables a large language model (LLM) heavy API configured to use multi-agent optimization to process the vessel's trajectory, speed, and environmental factors (e.g., wind speeds up to 20 knots, river currents, etc.) to determine a delivery window (e.g., 5-10 minutes) within a VLOS thereby achieving improved accuracy.

At block 514, the method 500 enables a pilot (or automated structure such as a robotic arm) at the delivery zone to pack the ordered items into payload bags, each designed for up to specified weight such as, for example, 30 pounds. In some implementations, a delivery microservice may ensure that a UAV's battery charge exceeds a specified level (e.g., 80%) and complies with specified regulations.

At block 516, the method 500 detects (e.g., via sensors such as optical, GPS, etc.) the pilot dispatching the UAV from a shore-based zone when the vessel is located within a VLOS (e.g., up to 2 miles). Likewise, the UAV navigates using GPS coordinates and locks onto an ArUco marker (e.g., marker 305 in FIG. 3A) on the vessel's payload catch arm (e.g., payload catch arm structure 102 in FIG. 1A), maintaining a specified distance accuracy threshold (e.g., +5-meters) with pilot oversight to adjust for vessel movement and wind.

At block 518, the method 500 enables the pilot to remotely guide the UAV to drop the payload onto the payload catch arm. In some implementations, the payload catch arm includes a servo-motor that rotates (e.g., 180 degrees) to secure the payload. The servo motor may be configured to handle up to 50 pounds in, for example, 20-knot winds with solar-powered backup power for motor operation. If the payload is determined to be less than 50 pounds and the delivery succeeds, the method 500 proceeds to step 522. If the payload is determined to be greater than 50 pounds or the delivery fails (e.g., a missed catch), the method 500 proceeds to step 520.

At block 520, the method 500 addresses orders exceeding 50 pounds. For example, a second UAV may be dispatched within a VLOS with a pilot synchronizing multiple flights until an entire order is delivered.

At block 522, the method 500 confirms each successful drop via, for example, a 900 MHz telemetry within a VLOS and the feedback microservice transmits a real-time notification to the mariner's application. The notification may include a delivery timestamp and GPS confirmation.

At block 522, the method 500 manages delivery failures. For example, if the UAV misses the payload catch arm or loses VLOS, it returns to the shore-based zone, logs the issue with an error code (e.g., E01-MissedDrop), and retries up to, for example, two times. If unsuccessful, a feedback microservice automatically initiates a return process.

In some implementations, a telemetry tracking microservice enables real-time tracking and validation of a marine vessel's position, speed, and trajectory to facilitate autonomous UAV deliveries within a pilot's visual line of sight (VLOS) as mandated by FAA regulations. This microservice integrates multiple data sources and advanced processing capabilities to ensure precise coordination for deliveries to vessels, such as ships or barges on a river, thereby enhancing operational efficiency and compliance with regulatory and commercial maritime standards. The telemetry tracking microservice initiates functionality by retrieving vessel-specific data, including the vessel's unique identifier, planned route, and current speed (ranging from, for example, 0 to 20 knots) either through manual input by the mariner via a mobile application (react native interface) or automatically via a marine traffic application programming interface (API). The marine traffic API provides real-time automatic identification system (AIS) data updated, for example, every 30 seconds to ensure accurate tracking of the vessel's position and movement along inland waterways. Once vessel data is acquired, the telemetry tracking microservice processes real-time GPS coordinates and AIS data to monitor the marine vessel's location relative to a designated shore-based delivery zone. The telemetry tracking microservice is configured to predict when the marine vessel will enter a pilot's VLOS (e.g., a maximum radius of 2 miles from the delivery zone) in compliance with FAA regulation requirements. The telemetry tracking microservice may be configured to evaluate whether the vessel's speed is less than, for example, 20 knots and confirm that a current or predicted position avoids restricted waterway zones (e.g., FAA no-fly zones). If the vessel is projected to be within a VLOS within, for example, 30 minutes, the telemetry tracking microservice may signal the system to proceed with order fulfillment and an associated delivery window calculation. Otherwise, the telemetry tracking microservice may continue tracking or may trigger a notification to a mariner via, for example, SMS or email through a feedback microservice thereby prompting route adjustments or order delays. The telemetry tracking microservice may leverage an LLM (e.g., a Grok 4 heavy API) for enhanced trajectory analysis using multi-agent optimization to integrate environmental factors such as wind speeds (up to 20 knots) and river currents specific to a specified river. This enables precise prediction of the vessel's delivery coordinates with, for example, +5-meter accuracy thereby ensuring the UAV may target the vessel's payload catch arm effectively. The telemetry tracking microservice may operate on a scalable cloud infrastructure (e.g., AWS) maintaining data integrity with AES-256 encryption to meet security standards. Likewise, the telemetry tracking microservice may log all tracking data including timestamps and error codes (e.g., E02-OutOfVLOS for vessels beyond 2 miles) to support system diagnostics. This microservice enables dynamic vessel tracking and delivery synchronization within VLOS thereby ensuring operational reliability and regulatory compliance.

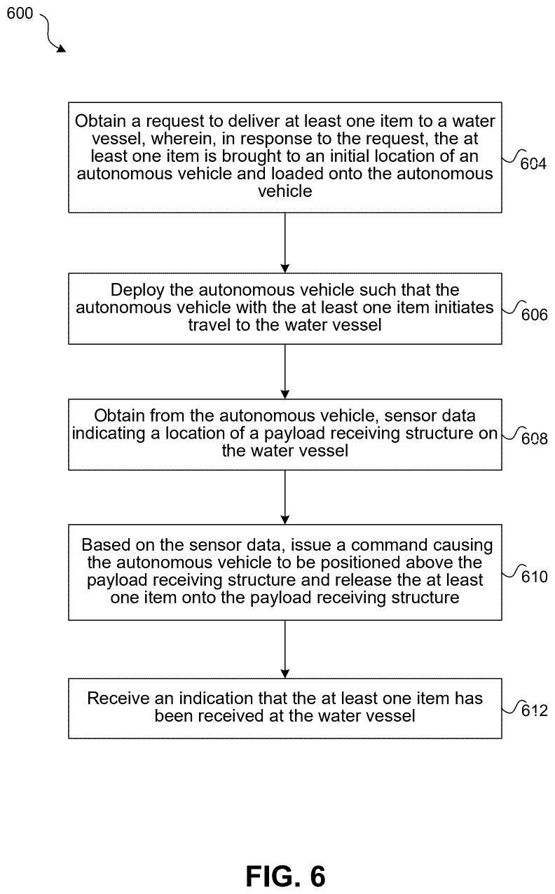

FIG. 6 illustrates is a flowchart representation of an exemplary method 500 enabling a system to control an autonomous vehicle payload delivery sequence with respect to a moving vessel, in accordance with some implementations. In some implementations, the method 600 may be performed by a device, such as a mobile device, desktop, laptop, a dedicated controller, or server device. In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 604, the method 600 obtains a request to deliver at least one item to a water vessel and in response to the request, the at least one item is brought to an initial location of an autonomous vehicle and loaded onto the autonomous vehicle. In some implementations, the water vessel is a marine vessel moving within a waterway and the autonomous vehicle is an aircraft. For example, a web application may receive an order from a customer. The order may include information associated with items (e.g., food, hardware, etc.) to be delivered, a customer's vessel location (current and anticipated) and during a time window for delivery as described in block 402 of FIG. 4. Likewise, an order may processed by an operations team at a mobile control center, items may packed into a secure delivery container and loaded (e.g., manually or via a robotic arm) on a UAV being prepared for launch as described in blocks 422, 424, 426 428 and 430 of FIGS. 4A-4D.

In some implementations the water vessel may be instructed to avoid restricted waterways associated with restricted airspace.

At block 606, the method 600 deploys the autonomous vehicle such that the autonomous vehicle with the at least one item initiates travel to the water vessel. For example, a UAV may be launched and begin autonomous navigation towards a moving marine vessel via a pre-calculated flight path as described at block 436 of FIGS. 4A-4D.

In some implementations, a position and movement of the water vessel may be tracked and based on the tracking, it may be determined that a speed of the moving water vessel is less than a predetermined threshold speed. In some implementations based on determining that a speed of the moving water vessel is less than a predetermined threshold speed, it may be determined that the moving water vessel will be within a visual line of sight (VLOS) with respect to the initial location of the autonomous vehicle within a specified time period. In some implementations, the deploying may be executed in response to determining that the moving water vessel will be within a VLOS within a specified time period.

In some implementations, tracking the position and movement of the moving water vessel may include using vessel-specific data including a vessel identifier, a vessel route, and a vessel speed to periodically update the position and movement of the water vessel to establish a real-time tracking baseline.

In some implementations, tracking the position and movement of the moving water vessel is based on environmental factors such as, inter alia, wind speeds, waterway current conditions, weather conditions, etc.

In some implementations, deploying the autonomous vehicle is based on a battery charge of a battery of the autonomous vehicle exceeding a threshold power value (e.g., 12 volts).

At block 608, the method 600 obtains from the autonomous vehicle, sensor data indicating a location of a payload receiving structure on the water vessel. For example, as a UAV approaches a vessel, it may use onboard sensors (e.g., GPS, cameras, etc.) to detect and confirm the vessel's position and the designated payload drop area as described at block 440 of FIGS. 4A-4D.

In some implementations, identification of the payload receiving structure is based on identification of an encoded marker integral with the payload receiving structure.

At block 610, the method 600 based on the sensor data, issues a command causing the autonomous vehicle to be positioned above the payload receiving structure and release the at least one item onto the payload receiving structure. For example, a UAV may adjust its descent and hover over a drop zone ready to release a package as described at block 440 of FIGS. 4A-4D.

In some implementations, the command may cause a motor of the payload receiving structure to activate to rotate a portion of the payload receiving structure to secure placement of the at least one item on the payload receiving structure. For example, an electrical motor 117 (e.g., rotary motor, stepper motor, linear movement motor, etc.) and controller may be used to articulate the platform structure 106 in a circular direction to ease unloading of payloads as described in FIG. 1.

At block 612, the method 600 receives (e.g., from the from the water vessel) an indication that the at least one item has been received at the water vessel. For example, a payload catch arm structure 102 may be configured to provide an indication that the payload has been received at the payload catch arm structure 102 as described in FIG. 1.

In some implementations, based on the indication, a second command causing the autonomous vehicle to return to the initial location may be issued. In some implementations, a second command causing the autonomous vehicle to return to the initial location may be issued.

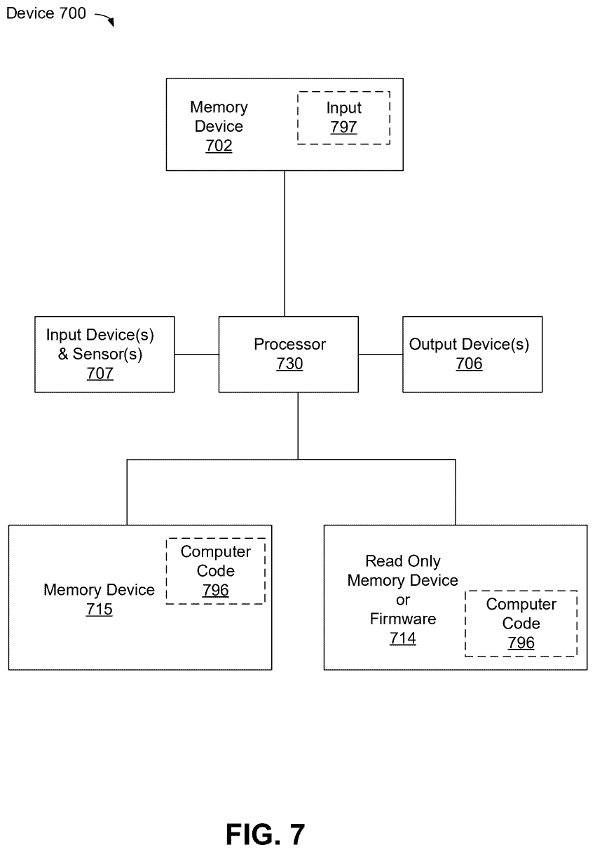

FIG. 7 illustrates a hardware device 700 used by the method of FIG. 4 for improving software/hardware implemented autonomous vehicle delivery technology associated with directing and controlling an autonomous vehicle to dynamically detect a moving vessel to fulfil an item request, in accordance with some implementations.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, spark, R language, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The hardware device 700 illustrated in FIG. 7 includes a processor 730, an input device/sensors 707 coupled to the processor 730, an output device 706 coupled to the processor 730, and memory devices 714 and 715 each coupled to the processor 730. The input device/sensors 707 may be, inter alia, a keyboard, a mouse, a camera, a touchscreen, any type of sensors, etc. The output device 706 may be, inter alia, a printer, a plotter, a computer screen, a magnetic tape, a removable hard disk, a floppy disk, etc. The memory devices 714 and 715 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 715 includes a computer code 796. The computer code 796 includes algorithms (e.g., the algorithm of FIGS. 4A-4D and 5-6) for improving software/hardware implemented autonomous vehicle delivery technology associated with directing and controlling an autonomous vehicle to dynamically detect a moving vessel to fulfil an item request. The processor 730 executes the computer code 796. The memory device 702 includes input data 797. The input data 797 includes input required by the computer code 796. The output device 706 displays output from the computer code 796. Either or both memory devices 714 and 715 (or one or more additional memory devices Such as read only memory device or firmware 714) may include algorithms (e.g., the algorithm of FIGS. 4A-4D and 5-6) and may be used as a computer usable medium (or a computer readable medium or a program storage device) having a computer readable program code embodied therein and/or having other data stored therein, wherein the computer readable program code includes the computer code 796. Generally, a computer program product (or, alternatively, an article of manufacture) of the Hardware device 700 may include the computer usable medium (or the program storage device).

In some embodiments, rather than being stored and accessed from a hard drive, optical disc or other writeable, rewriteable, or removable hardware memory device 715, stored computer program code 796 (e.g., including algorithms) may be stored on a static, nonremovable, read-only storage medium such as a Read-Only Memory (ROM) device 714, or may be accessed by processor 730 directly from such a static, nonremovable, read-only medium 714. Similarly, in some embodiments, stored computer program code 796 may be stored as computer-readable firmware 714, or may be accessed by processor 730 directly from such firmware 714, rather than from a more dynamic or removable hardware data-storage device 715, such as a hard drive or optical disc.

While FIG. 7 shows the hardware device 700 as a particular configuration of hardware and software, any configuration of hardware and software, as would be known to a person of ordinary skill in the art, may be utilized for the purposes stated supra in conjunction with the particular hardware device 700 of FIG. 7. For example, the memory devices 715 or 714 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method comprising:
at a device having a processor:
obtaining a request to deliver at least one item to a water vessel, wherein, in response to the request, the at least one item is brought to an initial location of an autonomous vehicle and loaded onto the autonomous vehicle;
deploying the autonomous vehicle such that the autonomous vehicle with the at least one item initiates travel to the water vessel;
obtaining from the autonomous vehicle, sensor data indicating a location of a payload receiving structure on the water vessel;
based on the sensor data, issuing a command causing the autonomous vehicle to be positioned above the payload receiving structure and release the at least one item onto the payload receiving structure; and
receiving an indication that the at least one item has been received at the water vessel.

2. The method of claim 1 further comprising:
based on the indication, issuing a second command causing the autonomous vehicle to return to the initial location.

3. The method of claim 1 further comprising:
issuing a second command causing the autonomous vehicle to return to the initial location.

4. The method of claim 1 further comprising:
tracking a position and movement of the water vessel;
based on the tracking, determining that a speed of the water vessel is less than a predetermined threshold speed; and
based on determining that a speed of the water vessel is less than a predetermined threshold speed, determining that the water vessel will be within a visual line of sight (VLOS) with respect to the initial location of the autonomous vehicle within a specified time period, wherein said deploying is executed in response to said determining that the water vessel will be within a VLOS within a specified time period.

5. The method of claim 4, wherein said tracking the position and movement of the water vessel comprises using vessel-specific data including a vessel identifier, a vessel route, and a vessel speed to periodically update the position and movement of the water vessel to establish a real-time tracking baseline.

6. The method of claim 5, wherein said tracking the position and movement of the water vessel is based on environmental factors.

7. The method of claim 6, wherein the environmental factors include wind speeds, waterway current conditions and weather conditions.

8. The method of claim 1, wherein the water vessel is a marine vessel moving within a waterway, and wherein the autonomous vehicle is an aircraft.

9. The method of claim 8, further comprising:
instructing the water vessel to avoid restricted waterways associated with restricted airspace.

10. The method of claim 1, wherein said deploying the autonomous vehicle is based on a battery charge of a battery of the autonomous vehicle exceeding a threshold power value.

11. The method of claim 1, wherein the identification of the payload receiving structure is based on identification of an encoded marker integral with the payload receiving structure.

12. The method of claim 1, wherein the command causes a motor of the payload receiving structure to activate to rotate a portion of the payload receiving structure to secure placement of the at least one item on the payload receiving structure.

13. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
obtaining a request to deliver at least one item to a water vessel, wherein, in response to the request, the at least one item is brought to an initial location of an autonomous vehicle and loaded onto the autonomous vehicle;
deploying the autonomous vehicle such that the autonomous vehicle with the at least one item initiates travel to the water vessel;
obtaining from the autonomous vehicle, sensor data indicating a location of a payload receiving structure on the water vessel;
based on the sensor data, issuing a command causing the autonomous vehicle to be positioned above the payload receiving structure and release the at least one item onto the payload receiving structure; and
receiving an indication that the at least one item has been received at the water vessel.

14. A payload receiving structure comprising:
a first elongated structure pivotably attached to a second elongated structure, the second elongated structure comprising an attachment structure configured to removably attach the second elongated structure to a structure on a vessel;
a third elongated structure pivotably attached to the first elongated structure; and
a platform structure comprising a porous platform, the platform structure attached to the third elongated structure such that the platform structure in combination with the third elongated member and the first elongated member is configured to rotate around the second elongated member to move the platform structure from a position associated with receiving an object from an autonomous vehicle to a position associated with removing the object from the platform structure.

15. The payload receiving structure of claim 14, further comprising:
an adjustable fastening structure configured to removably attach the payload catch arm structure to a structure on the vessel.

16. The payload receiving structure of claim 14, further comprising:
an electrical motor and controller configured to rotate the platform structure around the second elongated member to enable receiving the object from the autonomous vehicle removing the object from the platform structure.

17. The payload receiving structure of claim 14, further comprising:
an encoded marker place on the platform structure.

18. The payload receiving structure of claim 14, further comprising:
a battery pack structure mechanically attached to the payload receiving structure, wherein the battery pack structure comprises a battery pack and an enclosure retaining the battery pack.

19. The payload receiving structure of claim 14, further comprising:
a solar panel mechanically attached to the payload receiving structure.

20. The payload receiving structure of claim 14, further comprising an light emitting diode (LED) structure mechanically attached to the payload receiving structure.
